(19) United States
(12) Patent Application Publication
(10) Pub. No.: US 2018/0341441 A1
(43) Pub. Date: Nov. 29, 2018

(54) INFORMATION PROCESSING APPARATUS AND IMAGE FORMING APPARATUS

(71) Applicant: Oki Data Corporation, Tokyo (JP)

(72) Inventor: Naosato KOJIMA, Tokyo (JP)

(73) Assignee: Oki Data Corporation, Tokyo (JP)

(21) Appl. No.: 15/983,614

(22) Filed: May 18, 2018

(30) Foreign Application Priority Data
May 29, 2017 (JP) 2017-106011

(51) Int. Cl. G06F 3/12; H04L 12/12

(52) U.S. Cl. CPC G06F 3/1221; G06F 3/1226; H04L 12/12; G06F 3/1229

(57) ABSTRACT

An information processing apparatus according to one or more embodiments is operable in a first power mode and a second power mode that consumes less power than the first power mode. The information processing apparatus includes: a receiver that receives a packet transmitted through a communication line; a first controller that in the first power mode controls the information processing apparatus based on packets received by the receiver, and in the second power mode receives no power supply; and a second controller that in the second power mode receives power supply, and in the second power mode controls the information processing apparatus based on packets received by the receiver. Upon receiving a predetermined type of packet, the second controller responds with a packet while staying in the second power mode.

### CROSS REFERENCE TO RELATED APPLICATIONS

This application claims priority based on 35 USC 119 from prior Japanese Patent Application No. 201 7-1 0601 1 filed on May 29, 2017, entitled “ INFORMATION PROCESSING APPARATUS AND IMAGE FORMING APPARATUS”, the entire contents of which are incorporated herein by reference.

### BACKGROUND

The disclosure relates to an information processing apparatus and an image forming apparatus that have a power mode of reduced power consumption.

In a related art, an information processing apparatus is operable in a first power mode and a second power mode which consumes less power than the first power mode (see, for example, Patent Document 1)

Patent Document 1: Japanese Patent Application Publication No. 2014-210375.

### SUMMARY

Such conventional technology, however, faces a problem of frequent shifting from the second power mode to the first power mode, making it difficult for the apparatus to stay in the second power mode of the less power consumption. An object of an embodiment is to enable an apparatus to stay in a power mode that consumes less power.

An aspect of the disclosure is an information processing apparatus that is operable in a first power mode and a second power mode that consumes less power than the first power mode. The information processing apparatus includes: a receiver that receives a packet transmitted through a communication line; a first controller that in the first power mode controls the information processing apparatus based on packets received by the receiver, and in the second power mode receives no power supply; and a second controller that in the second power mode receives power supply, and in the second power mode controls the information processing apparatus based on packets received by the receiver. Upon receiving a predetermined type packet, the second controller responds with a packet while staying in the second power mode.

According to the above aspect, an apparatus can stay longer in a power mode that consumes less power.

### BRIEF DESCRIPTION OF DRAWINGS

FIG. 1 is a block diagram illustrating the control configuration of a printer according to one or more embodiments;

FIG. 2 is a diagram illustrating the configuration of an information processing system according to an embodiment;

FIG. 3 is a diagram illustrating network settings information according to an embodiment;

FIG. 4 is a diagram illustrating WSD information used for shifting to a sleep mode according to an embodiment;

FIG. 5 is a diagram illustrating WSD information used for shifting to a standby mode according to an embodiment;

FIG. 6 is a block diagram of functions in the standby mode according to an embodiment;

FIG. 7 is a block diagram of functions in the sleep mode according to an embodiment;

FIG. 8 is a diagram illustrating a WSD Probe packet according to an embodiment;

FIG. 9 is a diagram illustrating a WSD Probe Match packet according to an embodiment;

FIG. 10 is a diagram illustrating a WSD Resolve packet according to an embodiment;

FIG. 11 is a diagram illustrating a WSD Resolve Match packet according to an embodiment;

FIG. 12 is a sequence diagram depicting the flow of processing performed in shifting to the sleep mode according to an embodiment;

FIG. 13 is a sequence diagram depicting the flow of WSD Probe packet response processing according to an embodiment;

FIG. 14 is a sequence diagram depicting the flow of WSD Resolve packet response processing according to an embodiment; and

FIG. 15 is a sequence diagram illustrating the flow of processing performed in shifting back to the standby mode according to an embodiment.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only. One or more embodiments of an information processing apparatus and an image forming apparatus are described below with reference to the drawings.

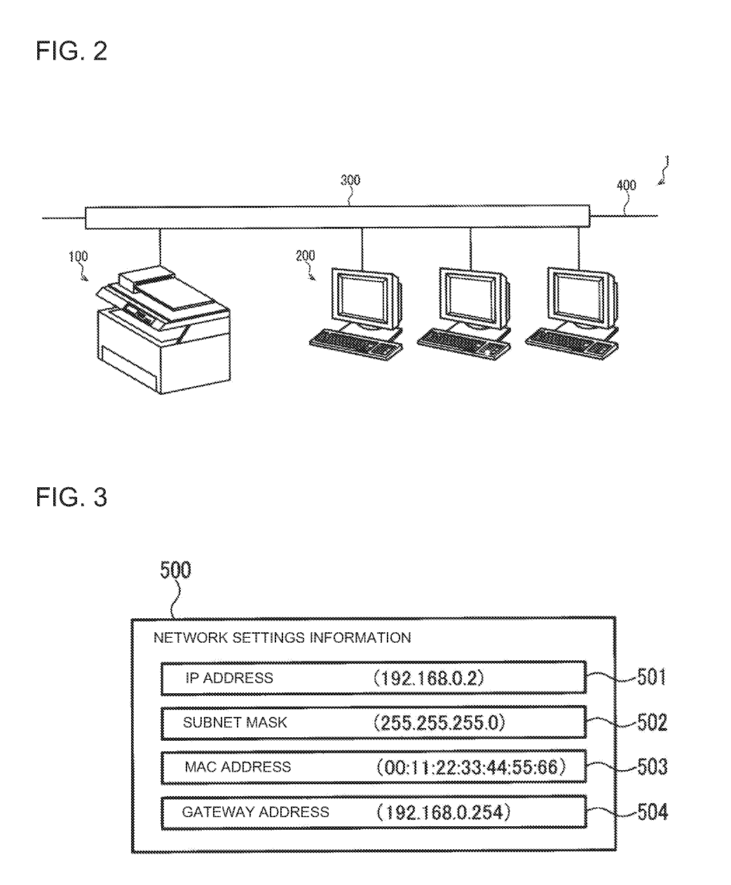

FIG. 2 is a diagram illustrating the configuration of an information processing system according to an embodiment.

In FIG. 2, an information processing system 1 has a printer 100, a personal computer (PC) 200, a switching hub 300, and a local area network (LAN) 400.

The printer 100 and the PC 200 are communicatively connected to each other via the LAN 400 (a communication line) including a connection device such as, for example, the switching hub 300. Note that in one embodiment, the printer 100 and the PC 200 perform communication control using a communication protocol such as the Transmission Control Protocol (TCP) or the User Datagram Protocol (UDP). Note that one or more printers 100 are connectable to the LAN 400 via the switching hub 300 or the like.

The printer 100, serving as an information processing apparatus, is for example a xerographic page printer. The printer 100 has a standby mode (a normal mode, a first power mode) and a sleep mode (a second power mode) that consumes less power than the standby mode, and is operable in the standby mode and the sleep mode. The printer 100 can switch between the standby mode and the sleep mode.

In the standby mode, the printer 100 can perform printing operation, and power is being supplied to all the power-consuming elements of the printer 100. In the sleep mode, it is aimed to reduce power consumption compared to the standby mode by shutting or reducing power supply to the power-consuming elements.

The printer 100 in the standby mode is shifted to the sleep mode after a predetermined period of time passes without receiving a command such as a print command or a settings command from the PC 200 or receiving any operation input given by a user through an operation and display part such as a touchscreen. Then, the printer 100 in the sleep mode shifts back to the standby mode when receiving a command such as a print command or a settings command from the PC 200 or receiving an operation input given by a user through the operation and display part such as a touchscreen.

Although described as being the printer 100 (an image forming apparatus) in one embodiment, the information processing apparatus may be a computer such as a PC. The PC 200 is a host computer or the like, and sends the printer 100 a print job (a print command). Note that one or more PCs 200 are connected to the LAN 400 via the switching hub 300.

Each PC 200 has a network-connected device checking function which sends the LAN 400 device-search data directed to any given device connected to the LAN 400, receives a response from the device that has received the data, and checks and keeps track of the device connected to the LAN 400. Specifically, each PC 200 keeps track of an apparatus connected to the LAN 400 by using the WS-Discovery Protocol (called “WS-Discovery” hereinbelow), which is a connected-device checking procedure for searching for and checking a device connected to the LAN 400.

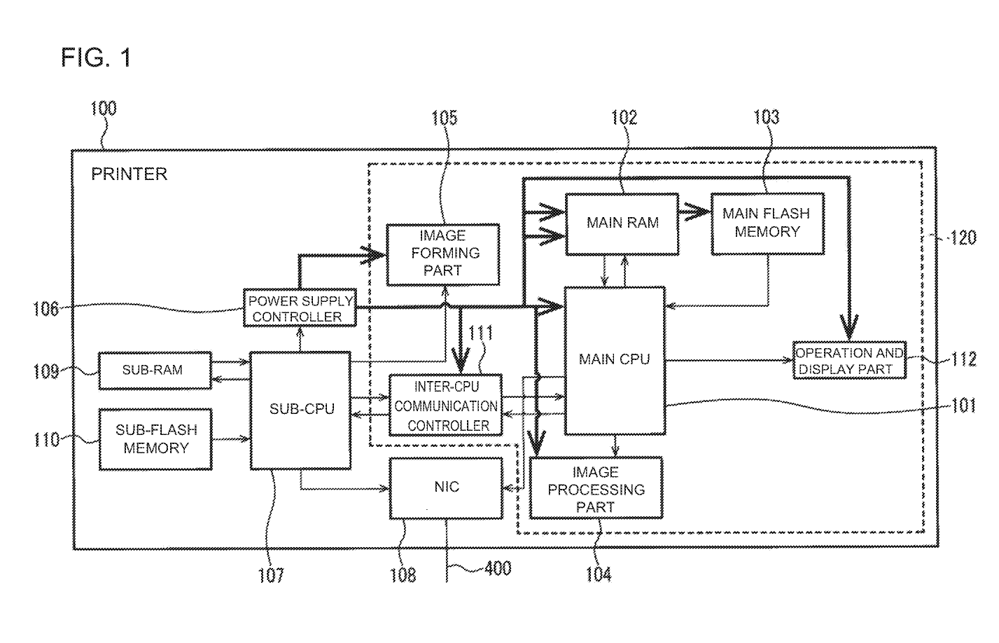

FIG. 1 is a block diagram illustrating the control configuration of the printer according to one or more embodiments.

In FIG. 1, the printer 100 has a main central processing unit (CPU) 101, a main random access memory (RAM) 102, a main FLASH memory 103, an image processing part 104, an image forming part 105, a power supply controller 106, a sub-CPU 107, a NIC 108, a sub-RAM 109, a sub-FLASH memory 110, an inter-CPU communication controller 111, and an operation and display part 112.

The main CPU 101 (a first controller) is a controller such as a microcomputer that operates in the standby mode, and implements various functions by controlling the overall operation of the printer 100 based on control programs stored in the main FLASH memory 103. The main CPU 101 takes control of elements necessary for a particular function, and when shifting to the sleep mode to reduce power consumption, shuts off power supply to part of the printer 100.

The main RAM 102 (a first storage) is a memory, such as for example a dynamic RAM (DRAM), to provide an arithmetic area necessary for the main CPU 101 to execute the control programs, and has a sufficiently large storage area. In the sleep mode, the main RAM 102 is set to a self-refresh mode and reduces power consumption.

The main FLASH memory 103 is a memory that stores information such as the control programs executed by the main CPU 101 and predetermined set values used for controlling the printer 100. This main FLASH memory 103 is a non-volatile memory, which means that stored information is retained even after power supply is shut off. The image processing part 104, as instructed by the main CPU 101, processes print data contained in a print job received from the PC 200 or the like and converts the print data into data in a printable format.

The image forming part 105 has a mechanic unit including a motor and the like to form an image on a print medium based on the printable data generated by the image processing part 104. In the sleep mode, power supply to a development unit, a transfer part, a fixation device, and the like constituting the mechanic unit is shut off. For example, the development unit includes components such as a photosensitive drum, an exposure device that forms a latent image based on print data, a toner cartridge that houses toner, and a development roller that forms a toner image on the photosensitive drum by supplying toner in the toner cartridge to the latent image on the photosensitive drum. The transfer part includes components such as a transfer roller that transfers the toner image formed on the photosensitive drum onto a medium. The fixation device includes components such as a heater for fixing the toner image transferred to the medium onto the medium.

The power supply controller 106 supplies power to the elements of the printer 100. In addition to the power supply to the entire printer 100, the power supply controller 106 is capable of switching between providing power supply and stopping power supply to each of the main CPU 101, the main RAM 102, the main FLASH memory 103, the image processing part 104, the image forming part 105, the inter-CPU communication controller 111, and the operation and display part 112 (pointed in FIG. 1 with heavy line arrows) independently. An area 120 surrounded by a broken line in FIG. 1 indicates an area where power supply is stopped in the sleep mode.

The sub-CPU 107 (a second controller) is a controller such as a microcomputer that operates in both of the standby mode and the sleep mode, and executes the control programs stored in the sub-FLASH memory 110. The sub-CPU 107 consumes less power than the main CPU 101. The sub-CPU 107 controls the image forming part 105 in the standby mode and controls the NIC 108 in the sleep mode.

The NIC 108 (a transmitter and a receiver) controls communication between the printer 100 and a device such as the PC 200 connected to the printer 100 via the LAN 400 and transmits and receives information. The NIC 108 as a receiver receives packets (data in predetermined transmission unit) transmitted from the PC 200 in FIG. 2 via the LAN 400, and the NIC 108 as a transmitter transmits response packets for the received packets to the PC 200 via the LAN 400.

This NIC 108 is controlled by the main CPU 101 in the standby mode and is controlled by the sub-CPU 107 in the sleep mode. Thus, by being controlled by the sub-CPU 107, the NIC 108 enables communications with the PC 200 connected to the LAN 400 in FIG. 2 in the sleep mode as well.

The sub-RAM 109 (a second storage) is a memory, such as for example a static RAM (SRAM), to provide an arithmetic area necessary for the sub-CPU 107 to execute the control programs. The sub-RAM 109 has a small storage area to reduce power consumption in the sleep mode.

The sub-FLASH memory 110 is a memory that stores control programs executed by the sub-CPU 107 in the standby mode and in the sleep mode. The control programs executed in the sleep mode include ones for issuing a command to control the NIC 108 and ones for controlling transmission and reception of information via the LAN 400. This sub-FLASH memory 110 is a non-volatile memory, which means that stored information is retained even after power supply to the printer 100 is shut off.

The inter-CPU communication controller 111 enables data and information such as commands to be transmitted and received between the main CPU 101 and the sub-CPU 107. The operation and display part 112 is a display and input part such as a touchscreen, and serves as both a display part that displays screens such as a settings screen and an operation part that receives a settings operation input given by a user. In one embodiment, the main CPU 101 in the standby mode controls the printer 100 based on packets received through the NIC 108 and in the sleep mode receives no power supply.

On the other hand, the sub-CPU 107 in the sleep mode receives power supply and in the sleep mode controls the printer 100 based on packets received through the NIC 108. Upon receiving a WS-Discovery packet (a predetermined packet) through the NIC 108 in the sleep mode, the sub-CPU 107 transmits a response packet for the received packet through the NIC 108 while staying in the sleep mode.

FIG. 3 is a diagram illustrating network settings information according to an embodiment.

In FIG. 3, network settings information 500 is information referred to when the NIC 108 in FIG. 1 performs communication control, and is made up of, for example, an IP address 501, a subnet mask 502, a media access control (MAC) address 503, and a gateway address 504. The network settings information 500 is passed from the main CPU 101 to the sub-CPU 107 in FIG. 1 through the inter-CPU communication controller 111 when the power mode is shifted to the sleep mode.

The IP address 501 is the IP address of the printer 100 in FIG. 2, the subnet mask 502 is the subnet mask of the printer 100, the MAC address 503 is the MAC address of the printer 100, and the gateway address 504 is the gateway address of the printer 100.

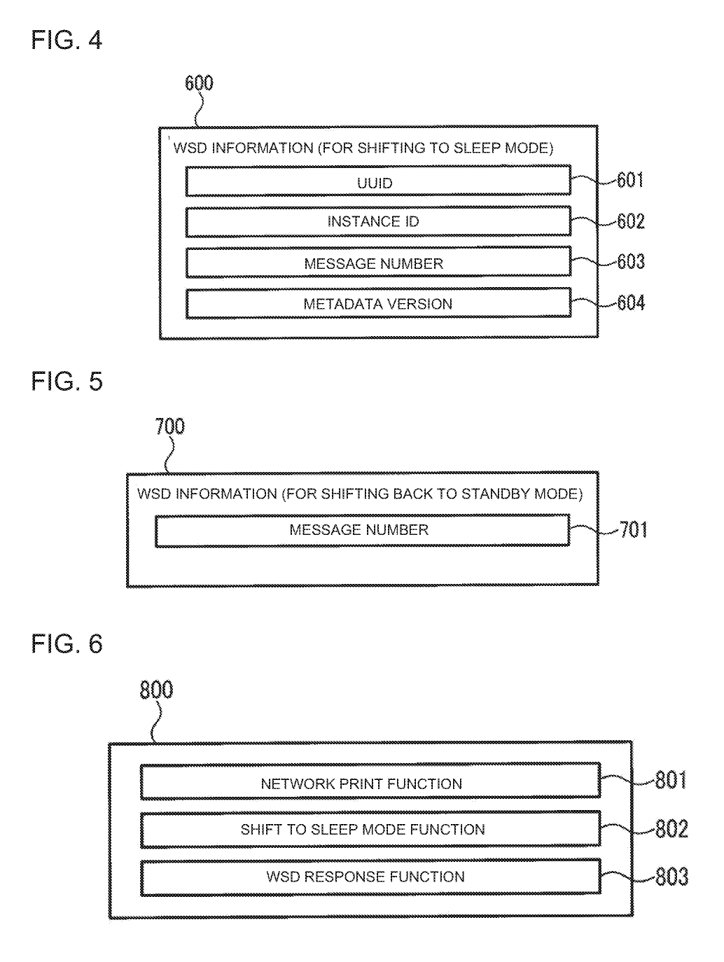

FIG. 4 is a diagram illustrating WSD information used for shifting to the sleep mode according to an embodiment, the WSD information being information on WS-Discovery (WSD) passed from the main CPU 101 to the sub-CPU 107 through the inter-CPU communication controller 111 when the printer 100 in FIG. 1 shifts from the standby mode to the sleep mode.

Herein, the WS-Discovery is a connected-device checking procedure that the PC 200 in FIG. 1 follows to search for and keep track of the printer 100 as a function connected to the LAN 400. When a predetermined condition is met, such as detection of any change in devices connected to the LAN 400, the PC 200 detects and keeps track of the printer 100 connected to the LAN 400 by transmitting a WS-Discovery search command packet called Probe, Resolve, or the like on the LAN 400 and receiving a response message packet from each printer 100 that has received the search command packet.

As described, each PC 200 in FIG. 2 keeps track of a device connected to the LAN 400 by using WS-Discovery for searching for a device connected to the LAN 400 and transmitting a search packet on the LAN 400 as device searching data and receiving a search response packet as a response from each device that has received the search packet.

In FIG. 4, WSD information 600 has a universally unique identifier (UUID) 601, an Instance ID 602, a Message Number 603, and a Metadata Version 604.

The UUID 601 is unique ID information as printer identification information used to identify the printer 100 in FIG. 1.

The Instance ID 602 is a value forming the element <wsd:AppSequence> in a WS-Discovery packet, and is incremented by one after every activation of a device (the printer 100).

The Message Number 603 as packet identification information is a value forming the element <wsd:AppSequence> in the WS-Discovery packet, and is incremented by one after every transmission of a WS-Discovery message (packet). This element <wsd:AppSequence> is information necessary for keeping messages in correct order and identifying the messages.

The Metadata Version 604 is a value forming the element <wsd:MetadataVersion> in the WS-Discovery packet.

FIG. 5 is a diagram illustrating WSD information according to an embodiment used for shifting to the standby mode, the WSD information being information on WS-Discovery (WSD) passed from the sub-CPU 107 to the main CPU 101 through the inter-CPU communication controller 111 when the printer 100 in FIG. 1 shifts back from the sleep mode to the standby mode.

WSD information 700 has a Message Number 701.

The Message Number 701 as packet identification information is a value forming the element <wsd:AppSequence> in the WS-Discovery packet, and is incremented by one after every transmission of a WS-Discovery message. Since this element <wsd:AppSequence> is necessary for keeping messages in correct order and identifying the messages, the Message Number 701 is incremented by one after every transmission of a message even in the sleep mode, and is passed from the sub-CPU 107 to the main CPU 101 when the printer 100 shifts back from the sleep mode to the standby mode.

The Message Numbers (603, 701) in FIGS. 4 and 5 are message numbers for keeping messages in correct order and identifying the messages, and are used to sort messages received on the receiving end in correct order.

FIG. 6 is a block diagram of functions in the standby mode according to an embodiment, illustrating functions that the main CPU 101 of the printer 100 in FIG. 1 has in the standby mode. Note that FIG. 6 illustrates a part of the functions of the main CPU 101 in the standby mode that is extracted for simplifying explanations of the embodiment.

In FIG. 6, functions 800 in the standby mode include a network print function 801, a shift to sleep mode function 802, and a WSD response function 803. The network print function 801 is a function that, in the standby mode, processes a packet representing a print request such as a print job or a settings request received through the LAN 400 in FIG. 1 and performs printing or settings.

The shift to sleep mode function 802 is a function that controls shifting from the standby mode to the sleep mode. The WSD response function 803 is a function that responds to WS-Discovery packets transmitted from the PC 200 in FIG. 2. Descriptions are given of functions for responding to a Probe packet and a Resolve packet among the WS-discovery packets.

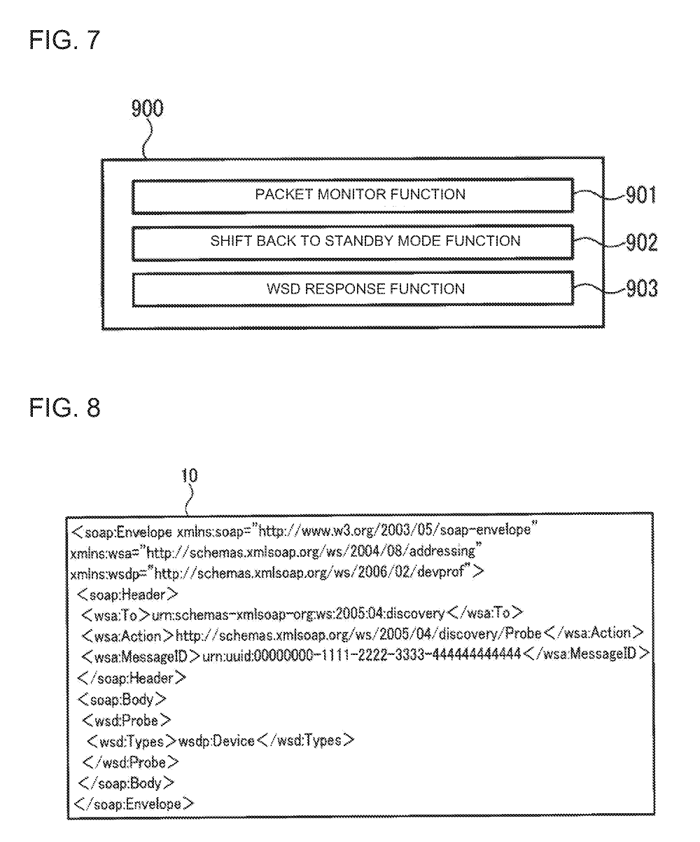

FIG. 7 is a block diagram of functions in the sleep mode according to an embodiment, illustrating functions that the sub-CPU 107 of the printer 100 in FIG. 1 has in the sleep modes. Note that FIG. 7 illustrates a part of the functions of the sub-CPU 107 in the sleep mode that is extracted for simplifying explanations of the embodiment.

In FIG. 7, functions 900 in the sleep mode include a packet monitor function 901, a shift back to standby mode function 902, and a WSD response function 903.

The packet monitor function 901, in the sleep mode, monitors reception of packets such as a request for connection to a TCP port. When the packet monitor function 901, in the sleep mode, detects a TCP port number that requires shifting back from the sleep mode to the standby mode, the packet monitor function 901 causes the shift back to standby mode function 902 to shift the power mode back from the sleep mode to the standby mode. Note that the packet monitor function 901 has a list of TCP port numbers that require shifting back to the standby mode.

The shift back to standby mode function 902 controls shifting back from the sleep mode to the standby mode. The shift back to standby mode function 902 controls shifting back to the standby mode upon receiving a command such as a print command or a settings command from the PC 200 in FIG. 2 or upon receiving an operation input given by a user through the operation and display part such as a touchscreen.

The WSD response function 903, in the sleep mode, responds to WS-Discovery packets transmitted from the PC 200 in FIG. 2. Descriptions are given of functions for responding to a Probe packet and a Resolve packet among the WS-discovery packets.

When the printer 100 shifts from the standby mode to the sleep mode, the sub-CPU 107 receives, from the main CPU 101 through the inter-CPU communication controller 111, the WSD information 600 in FIG. 4 as information necessary for responding to a WS-Discovery packet. FIG. 8 is a diagram illustrating a WSD Probe packet according to an embodiment. Note that this Probe packet is transmitted when the printer 100 is in the sleep mode.

In FIG. 8, a WS-Discovery Probe packet 10 is a WS-Discovery Probe packet transmitted from the PC 200 in FIG. 2 to the printer 100.

A value in the element <wsd:Types> in the WS-Discovery Probe packet 10 is “wsd:Device”, which indicates that the printer 100 needs to respond with a WS-Discovery Probe Match packet.

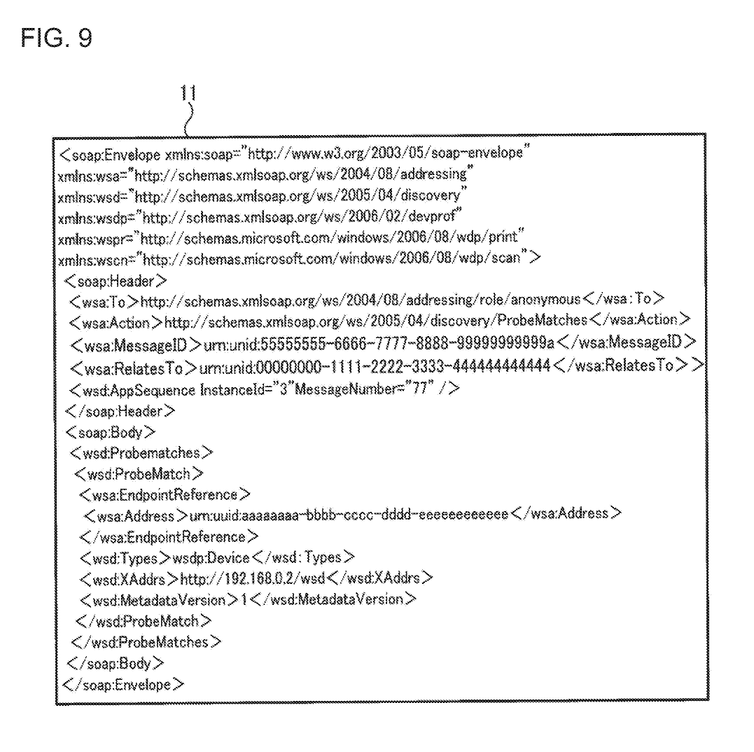

FIG. 9 is a diagram illustrating a WSD Probe Match packet according to an embodiment.

In FIG. 9, a WS-Discovery Probe Match packet 11 is a WS-Discovery Probe Match packet that the printer 100 in the sleep mode transmits in response to a WS-Discovery Probe packet transmitted from the PC 200 in FIG. 2 to the printer 100.

The element <wsd:AppSequence> in the WS-Discovery Probe Match packet 11 is generated by the printer 100 in FIG. 2 using the Instance ID 602 and the Message Number 603 in the WSD information 600 in FIG. 4. The printer 100 sets the Instance ID 602 to InstanceId and the Message Number 603 to MessageNumber. Further, the printer 100 updates the Message Number 603 by incrementing it by one after every transmission of a message.

The element <wsd:Address> is generated by the printer 100 in FIG. 2 using the UUID 601 in the WSD information 600 in FIG. 4. The element <wsd:XAddrs> is generated by the printer 100 in FIG. 2 using the IP address 501 in the network settings information 500 in FIG. 3. The element <wsd:MetadataVersion> is generated by the printer 100 in FIG. 2 using the Metadata Version 604 in the WSD information 600 in FIG. 4.

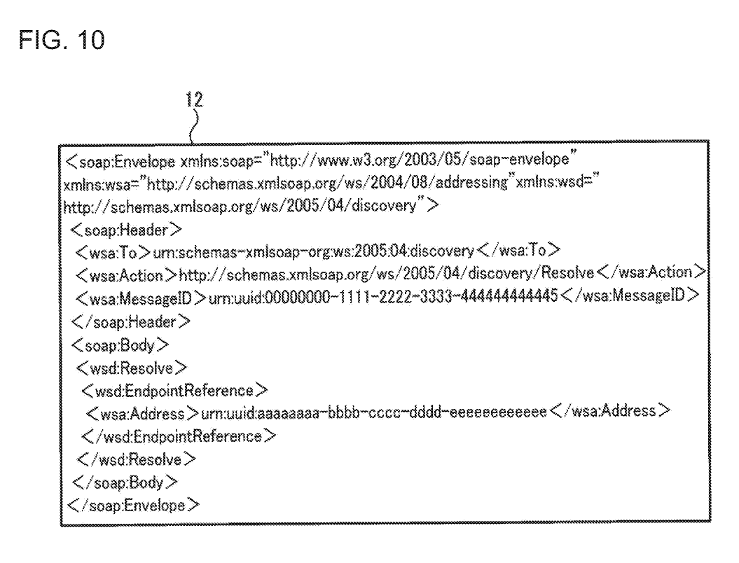

FIG. 10 is a diagram illustrating a WSD Resolve packet according to an embodiment. Note that this Resolve packet is transmitted when the printer 100 is in the sleep mode.

In FIG. 10, a WS-Discovery Resolve packet 12 is a WS-Discovery Resolve packet transmitted from the PC 200 in FIG. 2 to the printer 100.

A value in the element <wsd:Address> in the WS-Discovery Resolve packet 12 is, for example, “urn:uuid:00000000-1111-2222-3333-44444444444”, which indicates that it matches with the UUID of the printer 100 in FIG. 2 and that the printer 100 needs to respond with a WS-Discovery Resolve Match packet.

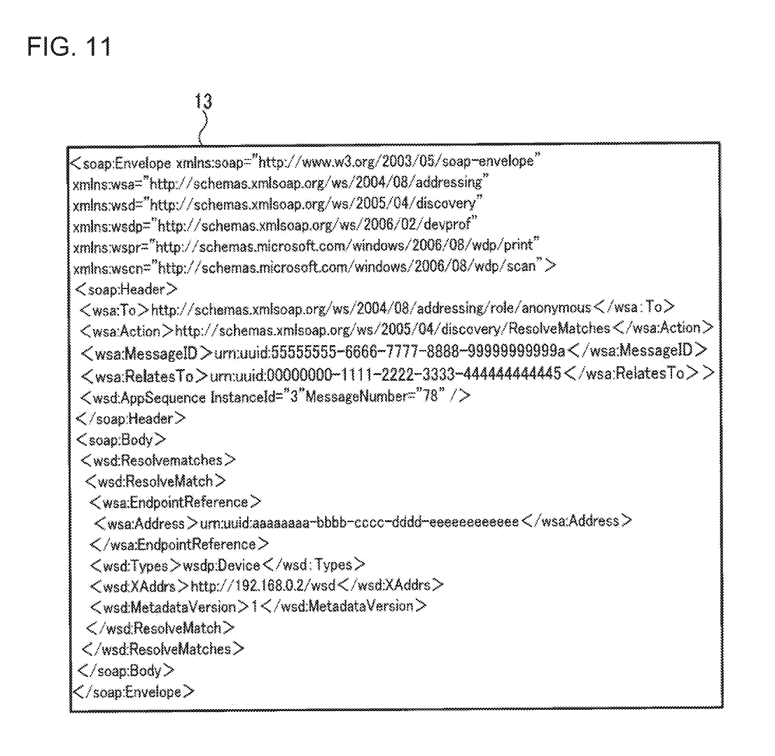

FIG. 11 is a diagram illustrating a WSD Resolve Match packet according to an embodiment.

In FIG. 11, a WS-Discovery Resolve Match packet 13 is a WS-Discovery Resolve Match packet that the printer 100 in the sleep mode transmits in response to a WS-Discovery Resolve packet transmitted from the PC 200 in FIG. 2 to the printer 100.

The element <wsd:AppSequence> in the WS-Discovery Resolve Match packet 13 is generated by the printer 100 in FIG. 2 using the Instance ID 602 and the Message Number 603 in the WSD information 600 in FIG. 4. The printer 100 sets the Instance ID 602 to InstanceId and the Message Number 603 to MessageNumber. Further, the printer 100 updates the Message Number 603 by incrementing it by one after every transmission of a message.

The element <wsd:Address> is generated by the printer 100 in FIG. 2 using the UUID 601 in the WSD information 600 in FIG. 4. The element <wsd:XAddrs> is generated by the printer 100 in FIG. 2 using the IP address 501 in the network settings information 500 in FIG. 3. The element <wsd:MetadataVersion> is generated by the printer 100 in FIG. 2 using the Metadata Version 604 in the WSD information 600 in FIG. 4.

A description is given of how the above-described configurations work.

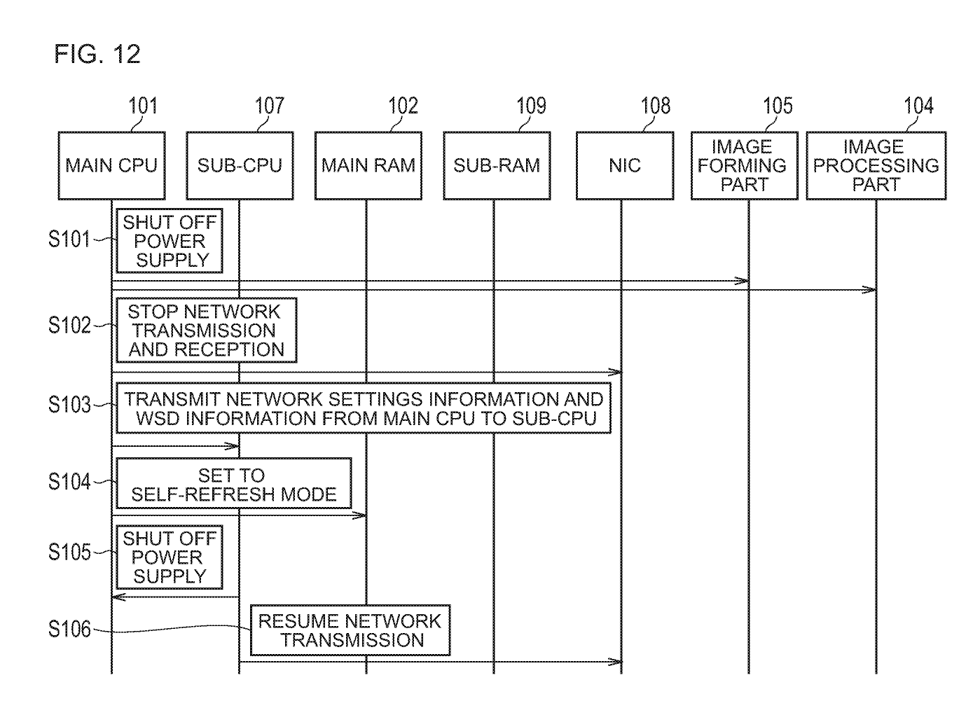

Based on FIGS. 12 to 15, a description is given of the flow of processing of shifting to the sleep mode after the activation of the printer 100 in FIG. 2 and then shifting back to the standby mode.

First, with reference to FIG. 12 as well as FIGS. 1 to 4, a description is given of the flow of processing that the printer 100 performs when shifting from the standby mode to the sleep mode after being activated. The description is given following the steps denoted by S in FIG. 12, a sequence diagram depicting the flow of processing performed in shifting to the sleep mode according to an embodiment.

When powered on and activated, the printer 100 performs initializing processing, and after finishing the initializing processing, shifts to the standby mode. The printer 100 having thus shifted to the standby mode shifts to the sleep mode to reduce power consumption after a predetermined period of time passes without receiving a command such as a print job from the PC 200 or receiving an operation input given by a user through the operation and display part 112.

S101: The main CPU 101 of the printer 100 shuts off power supply to the image forming part 105 and the image processing part 104.

S102: The main CPU 101 makes settings for the NIC 108 to stop network transmission and reception.

S103: The main CPU 101 transmits the network settings information 500 and the WSD information 600 to the sub-CPU 107 through the inter-CPU communication controller 111. Thus, when the printer 100 shifts from the standby mode to the sleep mode, the main CPU 101 passes to the sub-CPU 107 the network settings information 500 and the WSD information 600 including the Message Number 603 as response information to be used to respond to a WS-Discovery packet.

S104: The main CPU 101 sets the main RAM 102 to a self-refresh mode.

S105: The sub-CPU 107 shuts off power supply to the area 120 including the main CPU 101.

S106: The sub-CPU 107 makes settings for the NIC 108 to resume network transmission and reception, and the NIC 108 resumes network transmission and reception. The printer 100 shifts to the sleep mode, and with this, the processing ends.

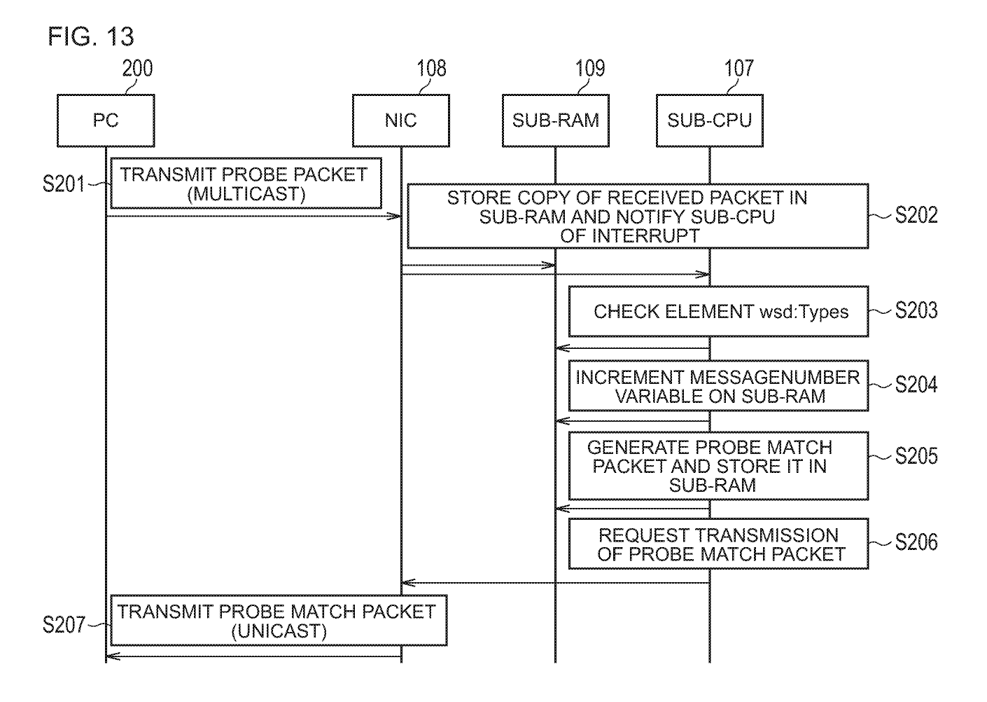

Next, with reference to FIG. 13 as well as FIGS. 1 to 4, a description is given of processing to respond to a WS-Discovery Probe packet performed when the printer 100 is in the sleep mode. The description is given following the steps denoted by S in FIG. 13, a sequence diagram depicting the flow of WSD Probe packet response processing according to an embodiment. The following assumes that the printer 100 has already shifted to the sleep mode.

S201: The PC 200 transmits a WS-Discovery Probe packet to the LAN 400 through multicast, addressed to all the printers 100 connected to the LAN 400. The Probe packet is for example the WS-Discovery Probe packet 10 in FIG. 8.

S202: The NIC 108 of the printer 100 receives the Probe packet, stores a copy of the Probe packet in the sub-RAM 109, and notifies the sub-CPU 107 of an interrupt signal.

S203: Notified of the interrupt signal, the sub-CPU 107 analyzes the Probe packet stored in the sub-RAM 109. For example, the sub-CPU 107 checks the element <wsd:Types> in the WS-Discovery Probe packet 10 in FIG. 8, and since the value of this element is “wsdp:Device”, determines that it is necessary to respond with a WS-Discovery Probe Match packet.

S204: Before transmitting a WS-Discovery Probe Match packet, the sub-CPU 107 updates the MessageNumber variable stored in the sub-RAM 109 by incrementing it by one. This MessageNumber variable is a variable assigned the value of the Message Number 603 of the WSD information 600 received from the main CPU 101 in the shifting to the sleep mode.

S205: The sub-CPU 107 generates a WS-Discovery Probe Match packet using the pieces of information in the WSD information 600 received from the main CPU 101 and the MessageNumber variable updated in S204, and stores the WS-Discovery Probe Match packet in the sub-RAM 109. The WS-Discovery Probe Match packet thus generated is for example the WS-Discovery Probe Match packet 11 in FIG. 9.

S206: The sub-CPU 107 requests the NIC 108 to transmit the WS-Discovery Probe Match packet stored in the sub-RAM 109.

S207: The NIC 108 transmits the WS-Discovery Probe Match packet stored in the sub-RAM 109 to the LAN 400, through unicast addressed to the PC 200 which is the sender of the Probe packet. With this, the processing ends.

As described, upon receiving a WS-Discovery Probe packet used in the WS-Discovery, the sub-CPU 107 sends back a WS-Discovery Probe Match packet as a response packet for the WS-Discovery Probe packet.

Note that the processing to respond to a WS-Discovery Probe packet performed when the printer 100 is in the standby mode is performed by the main CPU 101 and the main RAM 102 in place of the sub-CPU 107 and the sub-RAM 109 described above, respectively.

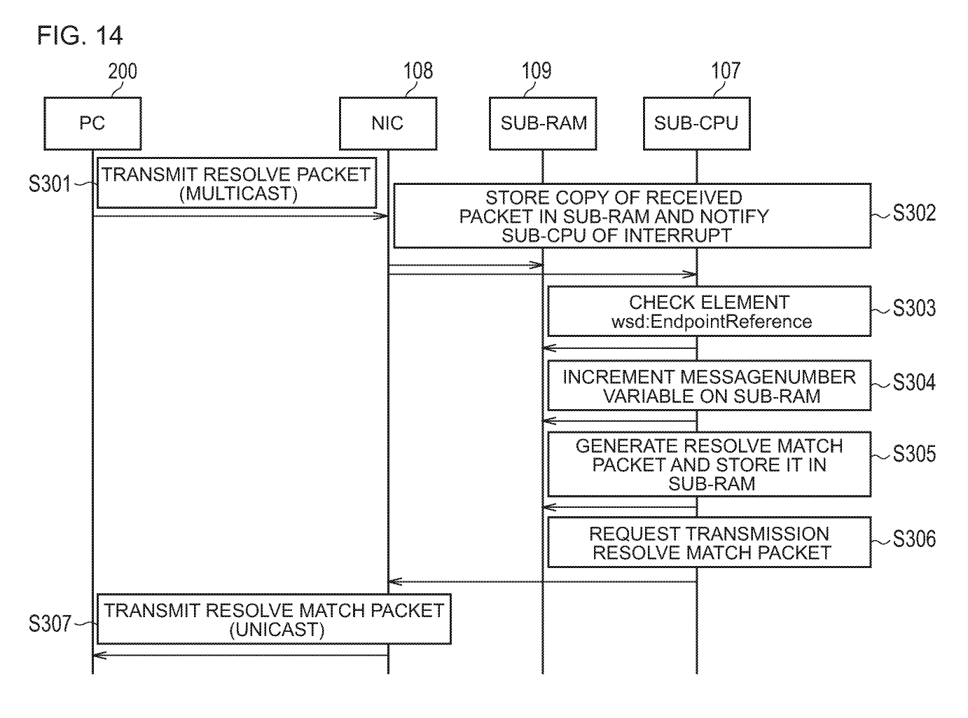

Next, with reference to FIG. 14 as well as FIGS. 1 to 4, a description is given of processing to respond to a WS-Discovery Probe packet performed when the printer 100 is in the sleep mode. The description is given following the steps denoted by S in FIG. 14, a sequence diagram depicting the flow of WSD Resolve packet response processing according to an embodiment. The following assumes that the printer 100 has already shifted to the sleep mode.

S301: The PC 200 transmits a WS-Discovery Resolve packet to the LAN 400 through multicast, addressed to all the printers 100 connected to the LAN 400. This Resolve packet is for example the WS-Discovery Resolve packet 12 in FIG. 10.

S302: The NIC 108 of the printer 100 receives the Resolve packet, stores a copy of the Resolve packet in the sub-RAM 109, and notifies the sub-CPU 107 of an interrupt signal.

S303: Notified of the interrupt signal, the sub-CPU 107 analyzes the Resolve packet stored in the sub-RAM 109. For example, the sub-CPU 107 checks the element <wsd:Address> of the element <wsa:EndpointReference> in the WS-Discovery Resolve packet 12 in FIG. 10, and since the UUID indicated by the value of this element matches the UUID of the printer 100 (the UUID 601 of the WSD information 600), determines that it is necessary to respond with a WS-Discovery Resolve Match packet.

S304: Before transmitting a WS-Discovery Resolve Match packet, the sub-CPU 107 updates the MessageNumber variable stored in the sub-RAM 109 by incrementing it by one. This MessageNumber variable is the MessageNumber variable described earlier with reference to FIG. 13.

S305: The sub-CPU 107 generates a WS-Discovery Resolve Match packet using the pieces of information in the WSD information 600 received from the main CPU 101 and the MessageNumber variable updated in S304, and stores the WS-Discovery Probe Match packet in the sub-RAM 109. The WS-Discovery Resolve Match packet thus generated is for example the WS-Discovery Resolve Match packet 13 in FIG. 11.

S306: The sub-CPU 107 requests the NIC 108 to transmit the WS-Discovery Resolve Match packet stored in the sub-RAM 109.

S307: The NIC 108 transmits the WS-Discovery Resolve Match packet stored in the sub-RAM 109 to the LAN 400 through unicast addressed to the PC 200 which is the sender of the Resolve packet. With this, the processing ends.

As described, upon receiving a WS-Discovery Resolve packet used in the WS-Discovery, the sub-CPU 107 sends back a WS-Discovery Resolve Match packet as a response packet for the WS-Discovery Resolve packet.

Note that the processing to respond to a WS-Discovery Resolve packet performed when the printer 100 is in the standby mode is performed by the main CPU 101 and the main RAM 102 in place of the sub-CPU 107 and the sub-RAM 109 described above, respectively.

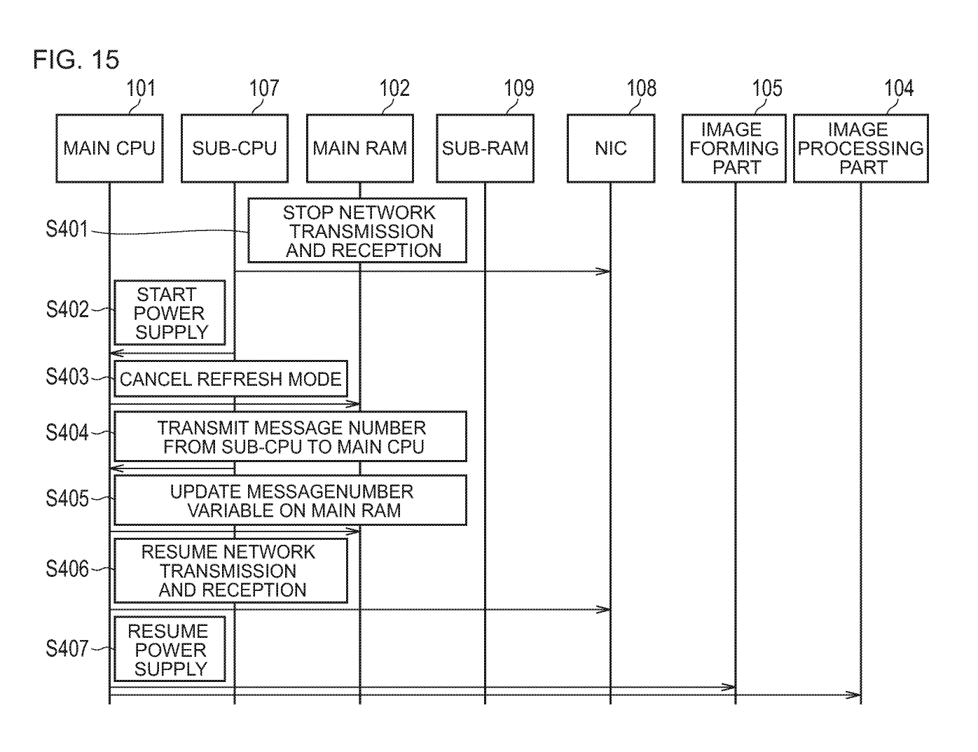

Next, with reference to FIG. 15 as well as FIGS. 1, 2, and 5, a description is given of the flow of processing that the printer 100 performs when shifting from the sleep mode to the standby mode. The description is given following the steps denoted by S in FIG. 15, a sequence diagram illustrating the flow of processing performed in shifting back to the standby mode according to an embodiment. Upon receiving, in the sleep mode, a command such as a print job from the PC 200 or an operation input given by a user through the operation and display part 112, the printer 100 shifts back to the standby mode to operate.

S401: The sub-CPU 107 makes settings for the NIC 108 to stop network transmission and reception.

S402: The sub-CPU 107 starts power supply to the main CPU 101.

S403: The main CPU 101 cancels the self-refresh mode of the main RAM 102.

S404: The sub-CPU 107 transmits the WSD information 700 including the Message Number 701 to the main CPU 101 through the inter-CPU communication controller 111. This Message Number 701 is the value of the MessageNumber variable updated in the processing of FIGS. 13 and 14.

Thus, when the printer 100 shifts from the sleep mode to the standby mode, the sub-CPU 107 passes the WSD information 700 including the Message Number 701 to the main CPU 101.

S405: Based on the value of the Message Number 701 received from the sub-CPU 107, the main CPU 101 updates the MessageNumber variable stored in the main RAM 102. The main CPU 101 sets the value of the Message Number 701 to the MessageNumber variable stored in the main RAM 102.

S406: The main CPU 101 makes settings for the NIC 108 to resume network transmission and reception, and the NIC 108 resumes network transmission and reception.

S407: The main CPU 101 resumes power supply to the image forming part 105 and the image processing part 104 and shifts back to the standby mode.

As described, when the printer 100 that has shifted to the sleep mode receives a WS-Discovery Probe packet or Resolve packet from sub-CPU 107, the printer 100 responds with a WS-Discovery Probe Match packet or a WS-Discovery Resolve Match packet while staying in the sleep mode. This allows the printer 100 to shift from the sleep mode to the standby mode less frequently and therefore to stay in the sleep mode that consumes less power than the standby mode.

By thus staying in the power mode consuming less power, power consumption of the printer 100 can be reduced.

Although the above describes cases where the printer 100 receives a WS-Discovery Probe packet and a WS-Discovery Resolve packet, the printer 100 may be configured to respond, while staying in the sleep mode, when receiving a packet that does not require the printer 100 to shift from the sleep mode to the standby mode (e.g., simple Network Management Protocol (SNMP) packets for monitoring and managing devices connected to the LAN 400 or packets that only request information from the printer 100). In this case, information necessary for the response is passed from the main CPU 101 to the sub-CPU 107 when the printer 100 shifts from the standby mode to the sleep mode.

As described above, the above embodiments advantageously enable the printer 100 to shift from the sleep mode to the standby mode less frequently and therefore to stay in the sleep mode consuming less power than the standby mode.

Hence, power consumption of the printer can be advantageously reduced.

Although the above embodiments describe the information processing apparatus as a printer, the invention is not limited thereto, and may be other apparatuses including computers such as personal computers and handheld information terminals.

Further, although the image forming apparatus has been described as a xerographic printer, the invention is not limited thereto, and may be an inkjet printer or an apparatus other than a printer, such as a copier, a facsimile machine, or a multifunction peripheral (MFP).

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. An information processing apparatus operable in a first power mode and a second power mode that consumes less power than the first power mode, the information processing apparatus comprising:
a receiver that receives a packet transmitted through a communication line;
a first controller that in the first power mode controls the information processing apparatus based on packets received by the receiver, and in the second power mode receives no power supply; and
a second controller that in the second power mode receives power supply, and in the second power mode controls the information processing apparatus based on packets received by the receiver, wherein
upon receiving a predetermined type packet, the second controller responds with a packet while staying in the second power mode.

2. The information processing apparatus according to claim 1, wherein
when the information processing apparatus shifts from the first power mode to the second power mode, the first controller passes to the second controller response information to be used to respond to the predetermined type packet.

3. The information processing apparatus according to claim 1, wherein
when the information processing apparatus shifts from the first power mode to the second power mode, the first controller passes packet identification information to the second controller.

4. The information processing apparatus according to claim 3, wherein
in the second power mode, the second controller updates the packet identification information after every response with a packet, and
when the information processing apparatus shifts from the second power mode to the first power mode, the second controller passes the packet identification information to the first controller.

5. The information processing apparatus according to claim 4, wherein
the packet identification information is a message number, and
the second controller increments the message number by one after every response with a packet.

6. The information processing apparatus according to claim 1, wherein
the predetermined type packet is a packet used in a connected-device checking procedure of checking a device connected to the communication line.

7. The information processing apparatus according to claim 6, wherein
the connected-device checking procedure is WS-Discovery,
the predetermined type packet is a WS-Discovery Probe packet used in the WS-Discovery, and
the packet with which to respond upon receipt of the predetermined type packet is a WS-Discovery Probe Match packet used in the WS-Discovery.

8. The information processing apparatus according to claim 6, wherein
the connected-device checking procedure is WS-Discovery,
the predetermined type packet is a WS-Discovery Resolve packet used in the WS-Discovery, and
the packet with which to respond upon receipt of the predetermined type packet is a WS-Discovery Resolve Match packet used in the WS-Discovery.

9. The information processing apparatus according to claim 7, wherein the packet identification information is MessageNumber.

10. The information processing apparatus according to claim 1, wherein the information processing apparatus is an image forming apparatus.

11. The information processing apparatus according to claim 1, comprising
an image processing part that outputs image data; and
an image forming part that prints an image represented by the image data on a medium.

12. An information processing apparatus operable in a first power mode and a second power mode that consumes less power than the first power mode, the information processing apparatus comprising:
an image forming part that print an image on a medium;
a receiver that receives a packet transmitted through a communication line;
a first controller that, in the first power mode, controls the information processing apparatus based on packets received by the receiver;
a second controller that, in the second power mode, controls the informing processing apparatus based on packets received by the receiver, wherein
when the information processing apparatus shifts from the first power mode to the second power mode, the first controller stops power supply to the image forming part and then the second controller stops power supply to the first controller,
upon receiving a predetermined type packet in the second power mode, the second controller responds with a packet while staying in the second power mode, and
upon receiving the other types of packet in the second power mode, the second controller starts power supply to the first controller and then the first controller starts power supply to the image forming part to shift the information processing apparatus from the second power mode to the first power mode.
